(19) United States
(12) Patent Application Publication
(10) Pub. No.: US 2014/0045593 A1
(43) Pub. Date: Feb. 13, 2014

(54) VIRTUAL JOINT ORIENTATION IN VIRTUAL SKELETON

(71) Applicants: Mauro Giusti, Redmond, WA (US); David Molyneaux, Kirkland, WA (US); Kevin Endres, Redmond, WA (US); John Elsbree, Bellevue, WA (US)

(72) Inventors: Mauro Giusti, Redmond, WA (US); David Molyneaux, Kirkland, WA (US); Kevin Endres, Redmond, WA (US); John Elsbree, Bellevue, WA (US)

(73) Assignee: MICROSOFT CORPORATION, Redmond, WA (US)

(21) Appl. No.: 13/569,145

(22) Filed: Aug. 7, 2012

(51) Int. Cl. A63F 13/06

(52) U.S. Cl. 463/32

(57) ABSTRACT

A method of modeling a human subject includes receiving from a depth camera a depth map of a scene including the human subject. The human subject is modeled with a virtual skeleton including a plurality of virtual joints. Each virtual joint is defined with a three-dimensional position. Furthermore, each of the plurality of virtual joints is further defined with three orthonormal vectors. The three orthonormal vectors for each virtual joint provide an orientation of that virtual joint at the three-dimensional position defined for that virtual joint.

### BACKGROUND

Some games and other computer applications attempt to model human subjects with on-screen avatars. However, it is difficult to render a lifelike avatar that accurately mimics the actual movements of a human subject in real time.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

This disclosure is directed to methods of modeling a human subject. In some embodiments, a human subject is modeled by receiving from a depth camera a depth map of a scene including the human subject. The human subject is modeled with a virtual skeleton including a plurality of virtual joints. Each virtual joint is defined with a three-dimensional position. Furthermore, each of the plurality of virtual joints is further defined with one or more orientation vectors (e.g., three orthonormal vectors). The orientation vector(s) for each virtual joint provide an orientation of that virtual joint.

### BRIEF DESCRIPTION OF THE DRAWINGS

FIGS. 1A and 1B show an example depth analysis system imaging a human subject in accordance with an embodiment of the present disclosure.

FIG. 2 schematically shows a nonlimiting example of a skeletal tracking pipeline in accordance with an embodiment of the present disclosure.

FIG. 3 shows a visual representation of a virtual skeleton in accordance with an embodiment of the present disclosure.

FIGS. 4-15 show example orientation vectors for various joints of the virtual skeleton of FIG. 3.

FIG. 16 shows a computing system in accordance with an embodiment of the present disclosure.

### DETAILED DESCRIPTION

The present disclosure is directed to heuristics for calculating virtual joint orientations for a virtual skeleton based on modeled joint locations and assumptions regarding human morphology.

As described in more detail below, a tracking device including a depth camera and/or other source is used to three-dimensionally image one or more observed humans. Depth information acquired by the tracking device is used to efficiently and accurately model and track the one or more observed humans. In particular, the observed human(s) may be modeled as a virtual skeleton or other machine-readable body model. The virtual skeleton or other machine-readable body model may be used as an input to control virtually any aspect of a computer. In this way, the computer provides a natural user interface that allows users to control the computer with spatial gestures.

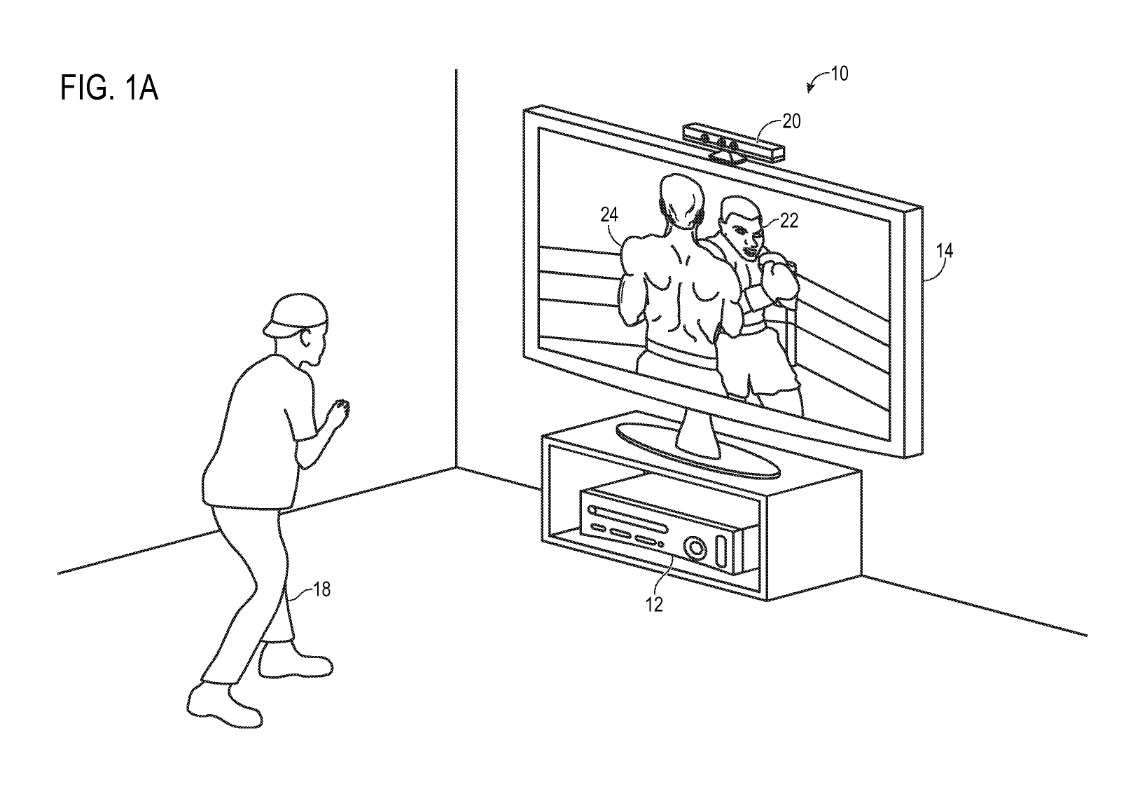

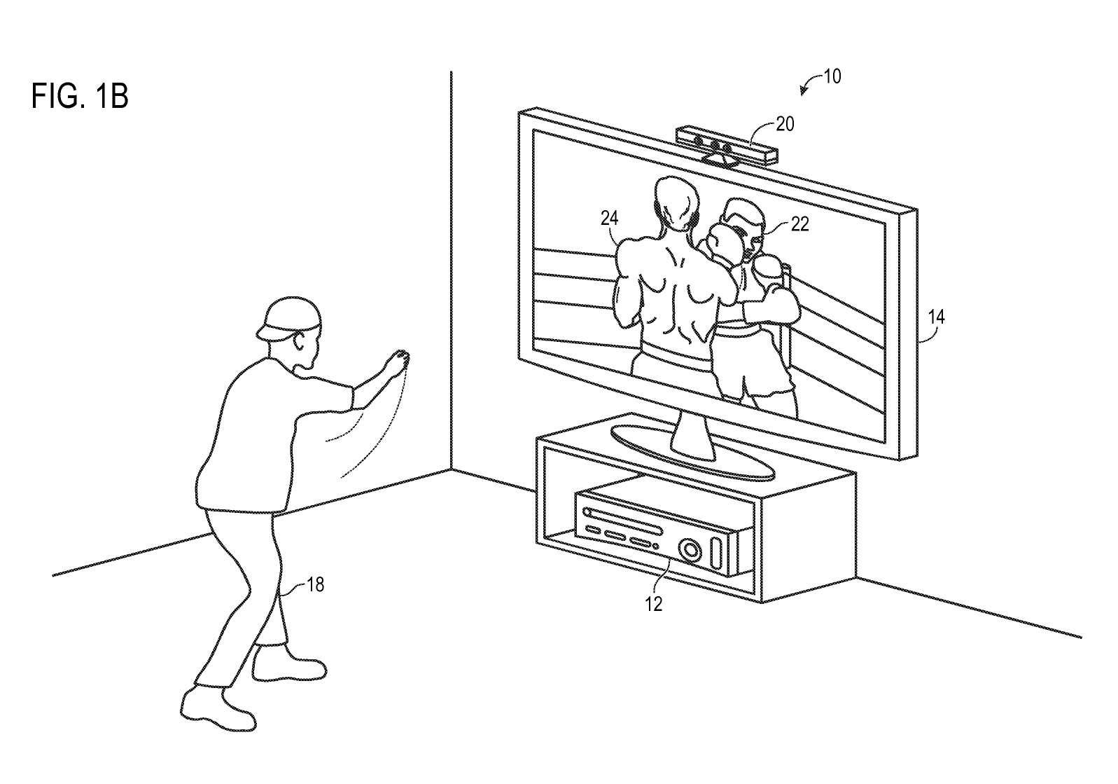

FIG. 1A shows a nonlimiting example of a depth anal analysis system 10. In particular, FIG. 1A shows a computer gaming system 12 that may be used to play a variety of different games, play one or wore different media types, and/or control or manipulate non-game applications. FIG. 1A also shows a display 14 that may be used to present game visuals to game players, such as game player 18. Furthermore, FIG. 1A shows a tracking device 20, which may be used to visually monitor one or more game players, such as game player 18. The example depth analysis system 10 shown in FIG. 1A is nonlimiting. A variety of different computing systems may utilize depth analysis for a variety of different purposes without departing from the scope of this disclosure.

A depth analysis system may be used to recognize, analyze, and/or track one or more human subjects, such as game player 18 (also referred to as human subject 18). FIG. 1A shows a scenario in which tracking device 20 tracks game player 18 so that the movements of game player 18 may be interpreted by gaming system 12. In particular, the movements of game player 18 are interpreted as controls that can be used to affect the game being executed by gaming system 12. In other words, game player 18 may use his movements to control the game. The movements of game player 18 may be interpreted as virtually any type of game control.

The example scenario illustrated in FIG. 1A shows game player 18 playing a boxing game that is being executed by gaming system 12. The gaming system uses display 14 to visually present a boxing opponent 22 to game player 18. Furthermore, the gaming system uses display 14 to visually present a player avatar 24 that gaming player 18 controls with his movements. As shown in FIG. 1B, game player 18 can throw a punch in physical space as an instruction for player avatar 24 to throw a punch in the virtual space of the game. Gaming system 12 and/or tracking device 20 can be used to recognize and analyze the punch of game player 18 in physical space so that the punch can be interpreted as a game control that causes player avatar 24 to throw a punch in virtual space. For example, FIG. 1B shows display 14 visually presenting player avatar 24 throwing a punch that strikes boxing opponent 22 responsive to game player 18 throwing a punch in physical space.

Other movements by game player 18 may be interpreted as other controls, such as controls to bob, weave, shuffle, block, jab, or throw a variety of different power punches. Furthermore, some movements may be interpreted as controls that serve purposes other than controlling player avatar 24. For example, the player may use movements to end, pause, or save a game, select a level, view high scores, communicate with a friend, etc.

Objects other than a human may be modeled and/or tracked. Such objects may be modeled and tracked independently of human subjects. An object held by a game player also may be modeled and tracked such that the motions of the player and the object are cooperatively analyzed to adjust and/or control parameters of a game. For example, the motion of a player holding a racket and/or the motion of the racket itself may be tracked and utilized for controlling an on-screen racket in a sports game.

Depth analysis systems may be used to interpret human movements as operating system and/or application controls that are outside the realm of gaming. Virtually any controllable aspect of an operating system, application, or other computing product may be controlled by movements of a human. The illustrated boxing scenario is provided as an example, but is not meant to be limiting in any way. To the contrary, the illustrated scenario is intended to demonstrate a general concept, which may be applied to a variety of different applications without departing from the scope of this disclosure.

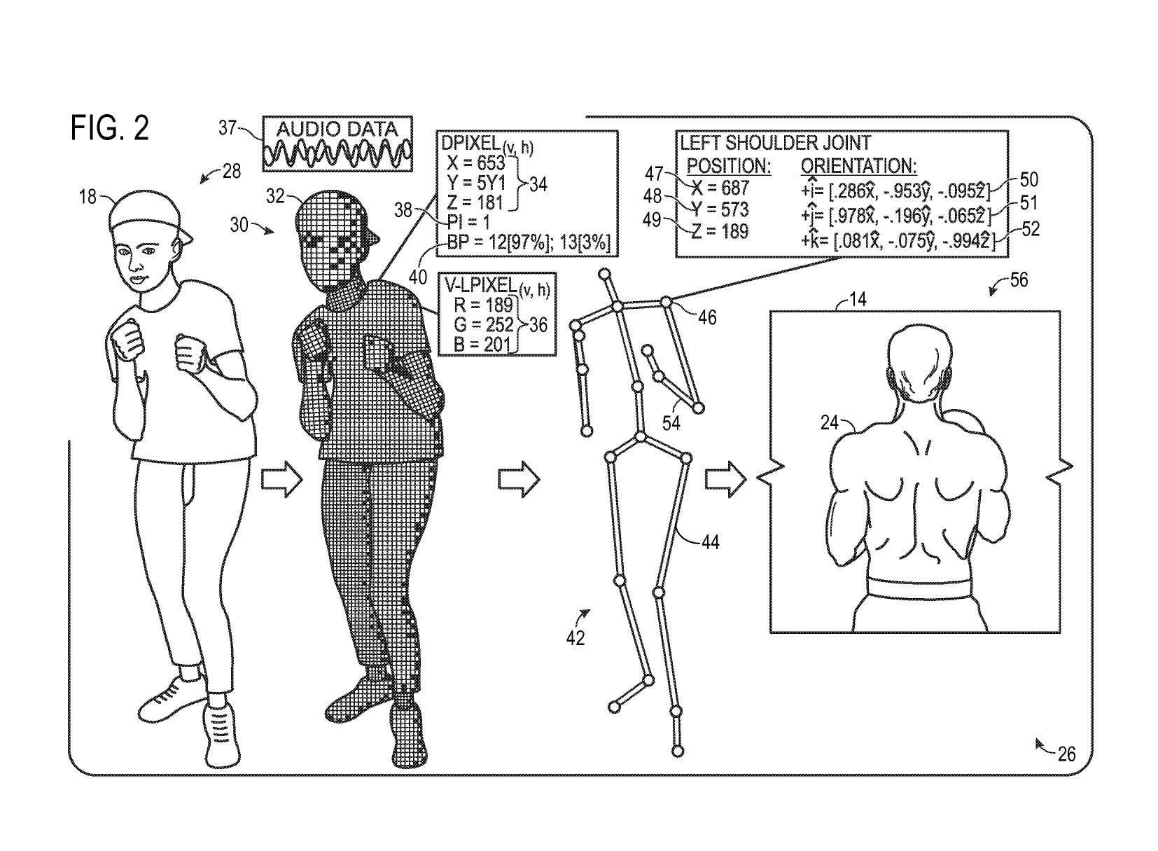

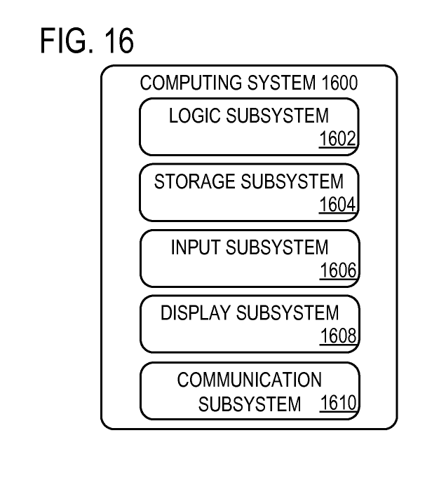

FIG. 2 graphically shows a simplified skeletal tracking pipeline 26 of a depth analysis system. For simplicity of explanation, skeletal tracking pipeline 26 is described with reference to depth analysis system 10 of FIGS. 1A and 1B. However, skeletal tracking pipeline 26 may be implemented on any suitable computing system without departing from the scope of this disclosure. For example, skeletal tracking pipeline 26 may be implemented on computing system 1600 of FIG. 16. Furthermore, skeletal tracking pipelines that differ from skeletal tracking pipeline 26 may be used without departing from the scope of this disclosure.

At 28, FIG. 2 shows game player 18 from the perspective of tracking device 20. A tracking device, such as tracking device 20, may include one or more sensors that are configured to observe a human subject, such as game player 18.

At 30, FIG. 2 shows a schematic representation 32 of the observation data collected by a tracking device, such as tracking device 20. The types of observation data collected will vary depending on the number and types of sensors included in the tracking device. In the illustrated example, the tracking device includes a depth camera, a visible light (e.g., color) camera, and a microphone.

A depth camera may determine, for each pixel of the depth camera, the depth of a surface in the observed scene relative to the depth camera. FIG. 2 schematically shows the three-dimensional x/y/z coordinates 34 observed for a DPixel[v,h] of a depth camera of tracking device 20. Similar three-dimensional x/y/z coordinates may be recorded for every pixel of the depth camera. The three-dimensional x/y/z coordinates for all of the pixels collectively constitute a depth map. The three-dimensional x/y/z coordinates may be determined in any suitable manner without departing from the scope of this disclosure. Example depth finding technologies are discussed in more detail with reference to FIG. 16.

A visible-light camera may determine, for each pixel of the visible-light camera, the relative light intensity of a surface in the observed scene for one or more light channels (e.g., red, green, blue, grayscale, etc.). FIG. 2 schematically shows the red/green/blue color values 36 observed for a V·LPixel[v,h] of a visible-light camera of tracking device 20. Similar red/green/blue color values may be recorded for every pixel of the visible-light camera. The red/green/blue color values for all of the pixels collectively constitute a digital color image. The red/green/blue color values may be determined in any suitable manner without departing from the scope of this disclosure. Example color imaging technologies are discussed in more detail with reference to FIG. 16.

The depth camera and visible-light camera may have the same resolutions, although this is not required. Whether the cameras have the same or different resolutions, the pixels of the visible-light camera may be registered to the pixels of the depth camera. In this way, both color and depth information may be determined for each portion of an observed scene by considering the registered pixels from the visible light camera and the depth camera (e.g., V·LPixel[v,h] and DPixel[v,h]).

One or more microphones may determine directional and/or nondirectional sounds coming from an observed human subject and/or other sources. FIG. 2 schematically shows audio data 37 recorded by a microphone of tracking device 20. Such audio data may be determined in any suitable manner without departing from the scope of this disclosure. Example sound recording technologies are discussed in more detail with reference to FIG. 16.

The collected data may take the form of virtually any suitable data structure(s), including but not limited to one or more matrices that include a three-dimensional x/y/z coordinate for every pixel imaged by the depth camera, red/green/blue color values for every pixel imaged by the visible-light camera, and/or time resolved digital audio data. While FIG. 2 depicts a single frame, it is to be understood that a human subject may be continuously observed and modeled (e.g., at 30 frames per second). Accordingly, data may be collected for each such observed frame. The collected data may be made available via one or more Application Programming Interfaces (APIs) and/or further analyzed as described below.

A tracking device and/or cooperating computing system optionally may analyze the depth map to distinguish human subjects and/or other targets that are to be tracked from non-target elements in the observed depth map. Each pixel of the depth map may be assigned a player index 38 that identifies that pixel as imaging a particular target or non-target element. As an example, pixels corresponding to a first player can be assigned a player index equal to one, pixels corresponding to a second player can be assigned a player index equal to two, and pixels that do not correspond to a target player can be assigned a player index equal to zero. Such player indices may be determined, assigned, and saved in any suitable manner without departing from the scope of this disclosure.

A tracking device and/or cooperating computing system optionally may further analyze the pixels of the depth map of a human subject in order to determine what part of that subject's body each such pixel is likely to image. A variety of different body-part assignment techniques can be used to assess which part of a human subject's body a particular pixel is likely to image. Each pixel of the depth map with an appropriate player index may be assigned a body part index 40. The body part index may include a discrete identifier, confidence value, and/or body part probability distribution indicating the body part, or parts, to which that pixel is likely to image. Body part indices may be determined, assigned, and saved in any suitable manner without departing from the scope of this disclosure.

As one nonlimiting example, machine-learning can be used to assign each pixel a body part index and/or body part probability distribution. The machine-learning approach analyzes a human subject using information learned from a prior-trained collection of known poses. In other words, during a supervised, training phase, a variety of different people are observed in a variety of different poses, and human trainers provide ground truth annotations labeling different machine-learning classifiers in the observed data. The observed data and annotations are used to generate one or more machine-learning algorithms that map inputs (e.g., observation data from a tracking device) to desired outputs (e.g., body part indices for relevant pixels).

At 42, FIG. 2 shows a schematic representation of a virtual skeleton 44 that serves as a machine-readable representation of game player 18. Virtual skeleton 44 includes twenty virtual joints—{head, shoulder center, spine, hip center, right shoulder, right elbow, right wrist, right hand, left shoulder, left elbow, left wrist, left hand, right hip, right knee, right ankle, right foot, left hip, left knee, left ankle, and left foot}. This twenty joint virtual skeleton is provided as a nonlimiting example. Virtual skeletons in accordance with the present disclosure may have virtually any number of joints.

The various skeletal joints may correspond to actual joints of a human subject, centroids of the human subject's body parts, terminal ends of a human subject's extremities, and/or points without a direct anatomical link to the human subject. Each joint has at least three degrees of freedom (e.g., world space x, y, z). As such, each joint of the virtual skeleton is defined with a three-dimensional position. For example, a left shoulder virtual joint 46 is defined with an x coordinate position 47, a y coordinate position 48, and a z coordinate position 49. The position of the joints may be defined relative to any suitable origin. As one example, a tracking device may serve as the origin, and all joint positions are defined relative to the tracking device. Joints may be defined with a three-dimensional position in any suitable manner without departing from the scope of this disclosure.

A variety of techniques may be used to determine the three-dimensional position of each joint. Skeletal fitting techniques may use depth information, color information, body part information, and/or prior trained anatomical and kinetic information to deduce one or more skeleton(s) that closely model a human subject. As one nonlimiting example, the above described body part indices may be used to find a three-dimensional position of each skeletal joint.

A joint orientation may be used to further define one or more of the virtual joints. Whereas joint positions may describe the position of joints and virtual bones that span between joints, joint orientations may describe the orientation of such joints and virtual bones at their respective positions. As an example, the orientation of a wrist joint may be used to describe if a hand located at a given position is facing up or down.

Joint orientations may be encoded, for example, in one or more normalized, three-dimensional orientation vector(s). The orientation vector(s) may provide the orientation of a joint relative to the tracking device or another reference (e.g., another joint). Furthermore, the orientation vector(s) may be defined in terms of a world space coordinate system or another suitable coordinate system (e.g., the coordinate system of another joint). Joint orientations also may be encoded via other means. As non-limiting examples, quaternions and/or Euler angles may be used to encode joint orientations.

FIG. 2 shows a nonlimiting example in which left shoulder joint 46 is defined with orthonormal orientation vectors 50, 51, and 52. In other embodiments, a single orientation vector may be used to define a join orientation. The orientation vector(s) may be calculated in any suitable manner without departing from the scope of this disclosure.

Joint positions, orientations, and/or other information may be encoded in any suitable data structure(s). Furthermore, the position, orientation, and/or other parameters associated with any particular joint may be made available via one or more APIs.

As seen in FIG. 2, virtual skeleton 44 may optionally include a plurality of virtual bones (e.g. a left forearm bone 54). The various skeletal bones may extend from one skeletal joint to another and may correspond to actual bones, limbs, or portions of bones and/or limbs of a human subject. The joint orientations discussed herein may be applied to these bones. For example, an elbow orientation may be used to define a forearm orientation.

At 56, FIG. 2 shows display 14 visually presenting avatar 24. Virtual skeleton 44 may be used to render avatar 24. Because virtual skeleton 44 changes poses as human subject 18 changes poses, avatar 24 accurately mimics the movements of human subject 18. It is to be understood, however, that a virtual skeleton may be used for additional and/or alternative purposes without departing from the scope of this disclosure.

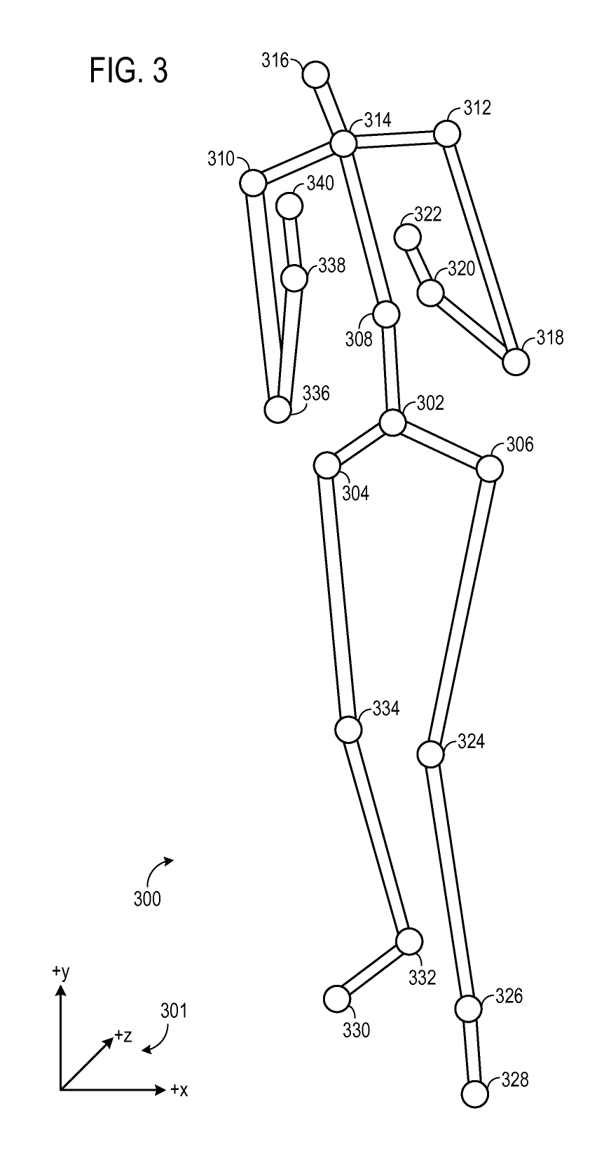

As introduced above, one or more joints of a virtual skeleton may be at least partially defined by an orientation. The following description provides nonlimiting heuristics for calculating joint orientations based on modeled joint locations and assumptions regarding human morphology. The example heuristics are described with reference to virtual skeleton 300, as shown in FIG. 3. Virtual skeleton 300 includes twenty virtual joints: hip center virtual joint 302, right hip virtual joint 304, left hip virtual joint 306, spine virtual joint 308, right shoulder virtual joint 310, left shoulder virtual joint 312, shoulder center virtual joint 314, head virtual joint 316, left elbow virtual joint 318, left wrist virtual joint 320, left hand virtual joint 322, left knee virtual joint 324 left ankle virtual joint 326, left foot virtual joint 328, right foot virtual joint 330, right ankle virtual joint 332, right knee virtual joint 334, right elbow virtual joint 336, right wrist virtual joint 338, and right hand virtual joint 340.

FIG. 3 also shows a world space coordinate system 301. While a left-handed x, y, z coordinate system is shown, joint orientations may be defined with reference to any suitable coordinate system without departing from the scope of this disclosure. Additional non-limiting examples include right-handed x, y, z, polar, spherical, and cylindrical coordinate systems.

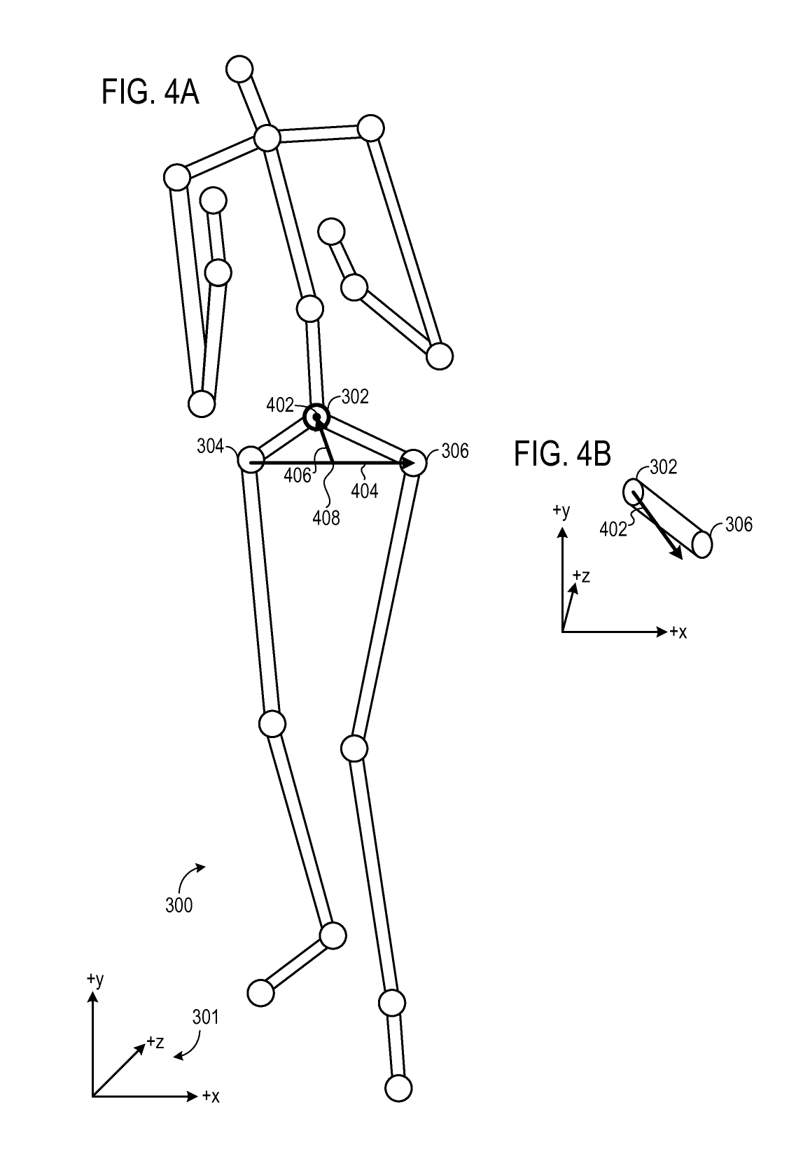

As seen in FIGS. 4A and 4B, an orientation of hip center virtual joint 302 may be defined with a hip center orientation vector 402. In FIG. 4A, hip center orientation vector 402 points substantially out of the page. FIG. 4B shows hip center orientation vector 402 from a different viewing angle (i.e., world space coordinate system 301 is slightly skewed to show hip center virtual joint from a different perspective). This convention is used below for the other joints. It is to be understood that these two-dimensional drawings are not intended to accurately illustrate the actual orientation of the vectors, but rather to demonstrate how such vectors can be calculated. As such, the orientations of the vectors are illustrated for simplicity of understanding, not technical accuracy. Likewise, the lengths of such vectors are not intended to indicate the magnitude of the vectors.

In the illustrated embodiment, hip center orientation vector 402 may be calculated as the normalized vector cross product of a vector 404 and a vector 406, where vector 404 extends between right hip virtual joint 304 and left hip virtual joint 306, and vector 406 extends between an average center point 408 between left and right hip virtual joints 304, 306 and hip center virtual joint 302. Hip center orientation vector 402, vector 404, and/or vector 406 may be associated with hip center virtual joint 302 and made available via an API.

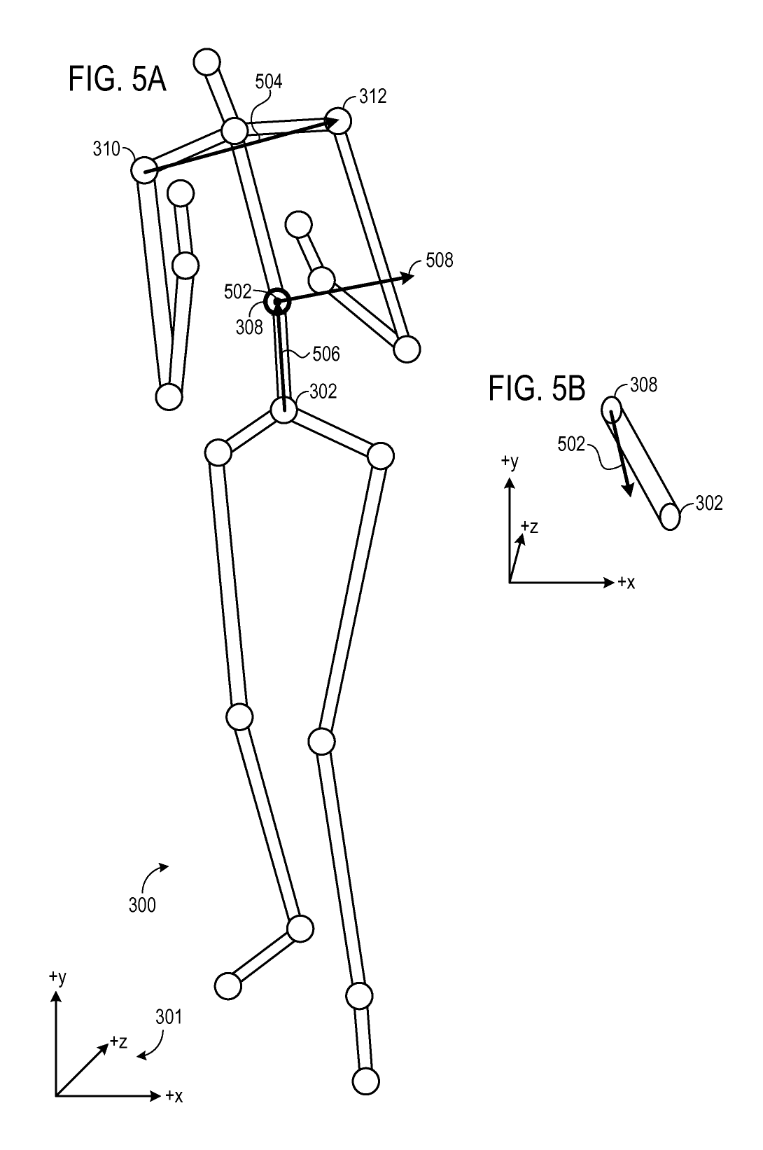

As seen in FIGS. 5A and 5B, an orientation of spine virtual joint 308 may be defined with a spine orientation vector 502 equal to the normalized vector cross product of a vector 504 and a vector 506, where vector 504 extends between right and left shoulder virtual joints 310, 312, and vector 506 extends between hip center virtual joint 302 and spine virtual joint 308. A local orthonormal coordinate system is ensured for spine virtual joint 308 by further defining a vector 508 equal to the normalized vector cross product of vector 506 and vector 502. The three spine joint orientation vectors 502, 506, and 508 together form an orthonormal coordinate system for spine virtual joint 308. Spine orientation vector 502, vector 506, and/or vector 508 may be associated with spine virtual joint 308 and made available via an API.

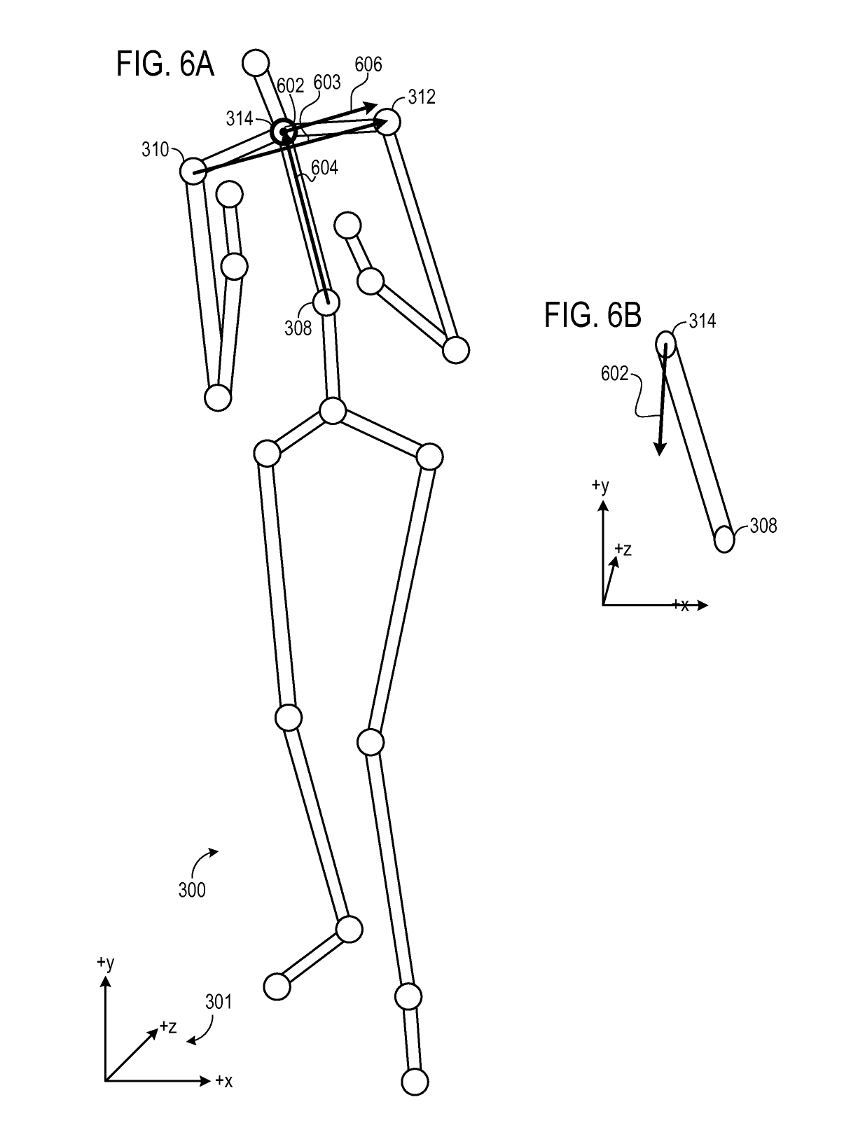

Moving to FIGS. 6A and 6B, an orientation of shoulder center virtual joint 314 may be defined with a shoulder center orientation vector 602. In the illustrated embodiment, shoulder center orientation vector 602 may be calculated as the normalized vector cross product of a vector 603 and a vector 604, where vector 604 extends between spine virtual joint 308 and shoulder center virtual joint 314, and vector 603 is equal to vector 504, described above. A local orthonormal coordinate system is ensured for shoulder center joint 314 by further defining a vector 606 equal to the normalized vector cross product of vector 604 and shoulder center orientation vector 602. The three shoulder center virtual joint orientation vectors 602, 604, and 606 together form an orthonormal coordinate system for shoulder center virtual joint 314. Shoulder center orientation vector 602, vector 604, and/or vector 606 may be associated with shoulder center virtual joint 314 and made available via an API.

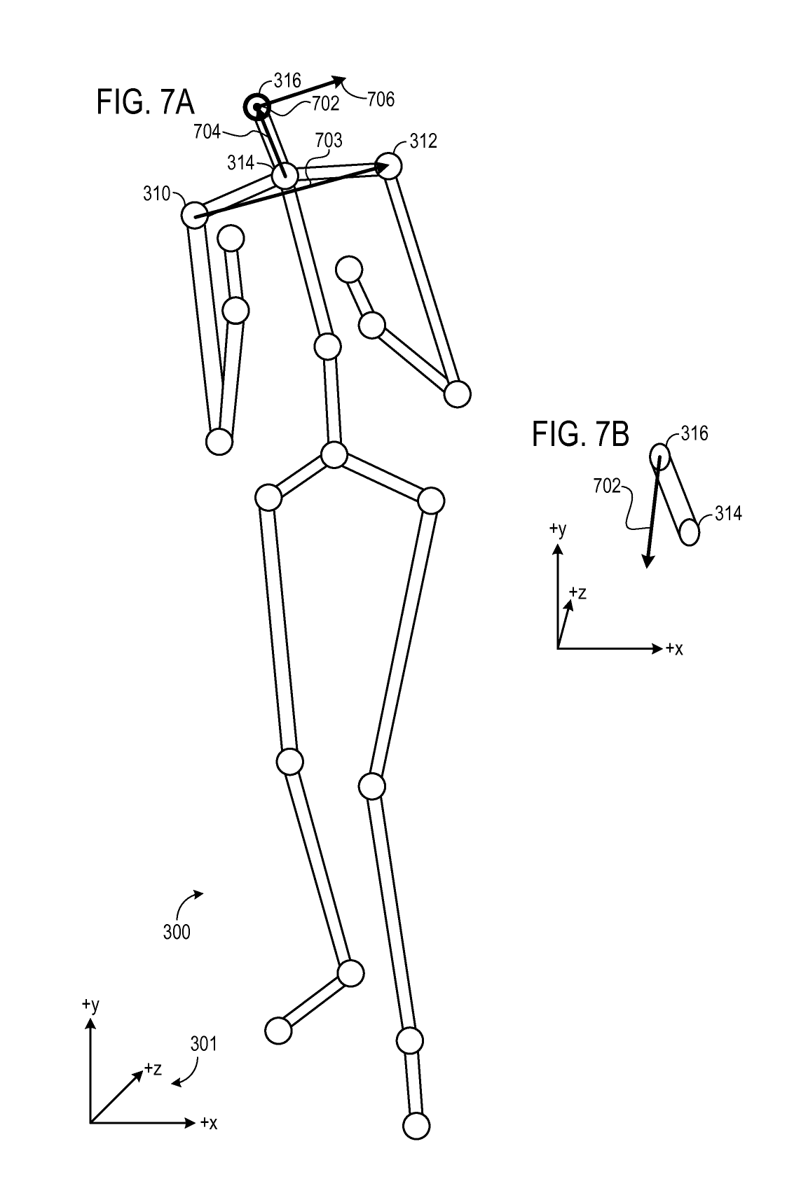

Turning now to FIGS. 7A and 7B, an orientation of head virtual joint 316 may be defined with a head orientation vector 702 equal to the normalized vector cross product of a vector 703 and a vector 704, where vector 704 extends between shoulder center joint 314 and head virtual joint 316, and vector 703 is equal to vector 504, described above. A local orthonormal coordinate system is ensured for head virtual joint 316 by further defining a vector 706 equal to the normalized vector cross product of vector 704 and head orientation vector 702. The three head joint orientation vectors 702, 704, and 706 together form an orthonormal coordinate system for head virtual joint 316. Head orientation vector 702, vector 704, and/or vector 706 may be associated with head virtual joint 316 and made available via an API.

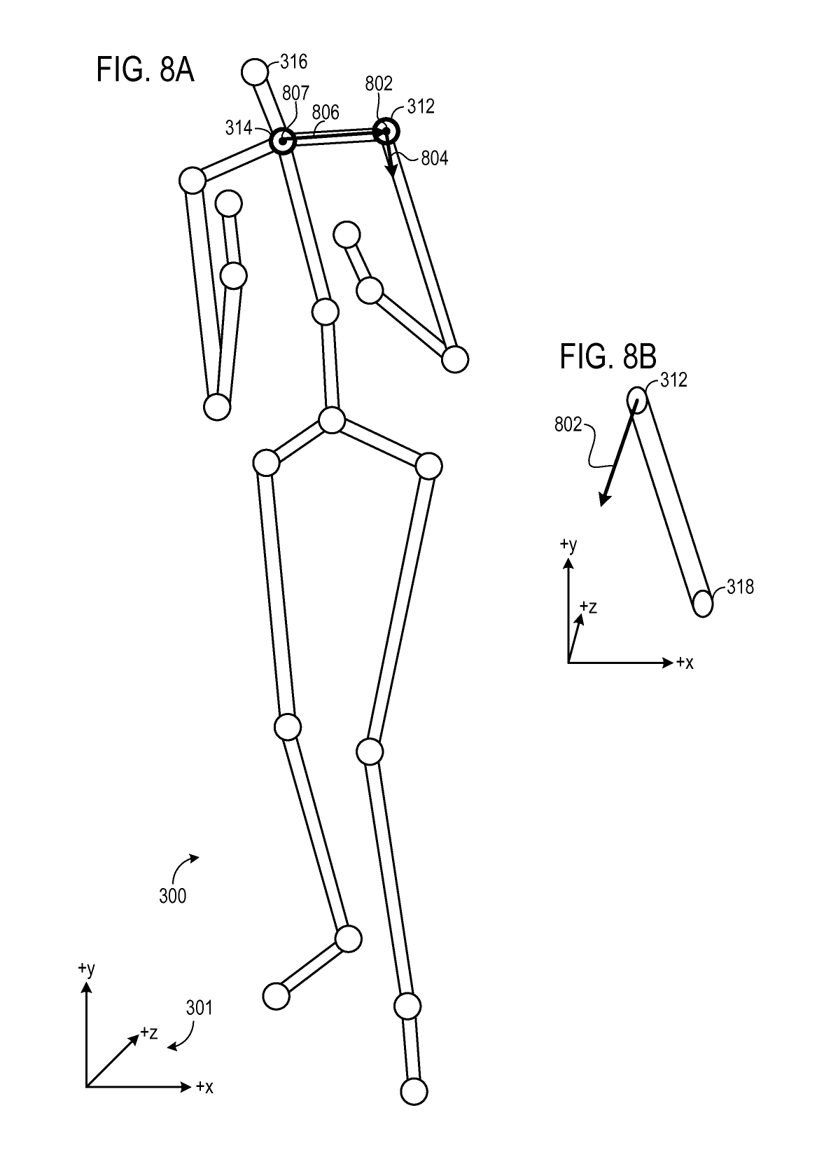

As seen in FIGS. 8A and 8B an orientation of left shoulder virtual joint 312 may be defined with a left, shoulder orientation vector 802. In the illustrated embodiment, an orientation of left shoulder virtual joint 312 is calculated by first finding a vector 804 equal to the normalized vector cross product of a vector 806 and a vector 807, where vector 806 extends between shoulder center virtual joint 314 and left shoulder virtual joint 312, and vector 807 is equal to vector 602, described above. Subsequently, an orthonormal coordinate system for left shoulder virtual joint 312 is ensured by calculating left shoulder orientation vector 802 as the normalized vector cross product of vector 804 and vector 806. The three left shoulder virtual joint vectors 802, 804, and 806 together form an orthonormal coordinate system for left shoulder virtual joint 312. Left shoulder orientation vector 802, vector 804, and/or vector 806 may be associated with left shoulder virtual joint 312 and made available via an API.

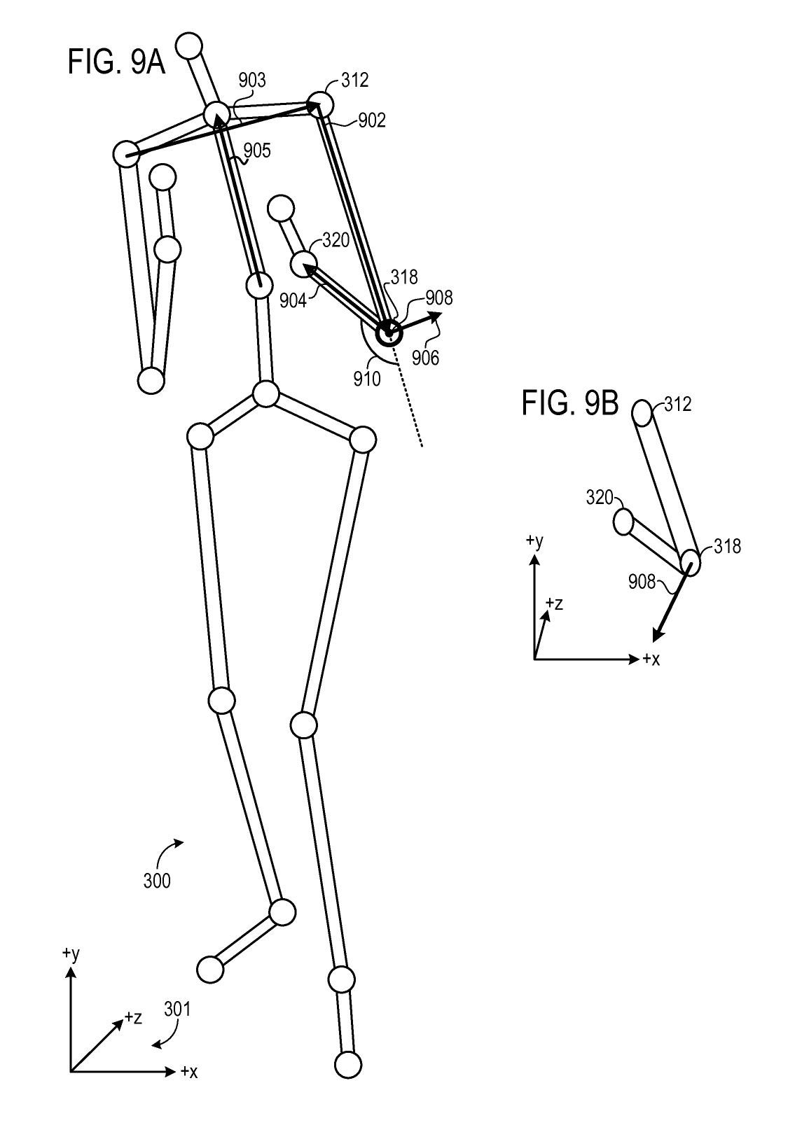

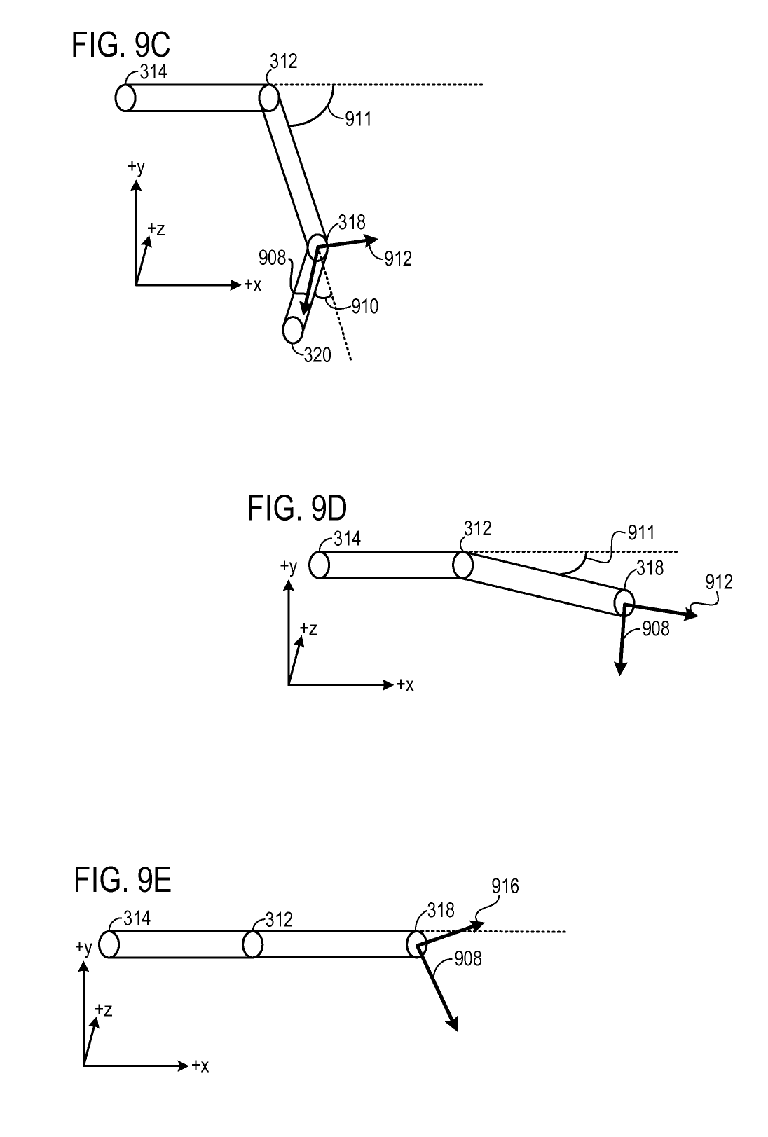

As seen in FIGS. 9A and 9B, determination of an orientation of left elbow virtual joint 318 begins with calculating a first vector dot product of a vector 902 and a vector 904, where vector 902 extends between left shoulder virtual joint 312 and left elbow virtual joint 318, and vector 904 extends between left elbow virtual joint 318 and left wrist virtual joint 320. If a first angle 910 determined by the first dot product exceeds a first threshold angle, the lower arm is used to constrain the calculation an orientation left, elbow virtual joint 318, which is calculated by first finding a vector 906 equal to the normalized vector cross product of vector 902 and vector 904. First angle 910 parameterizes and represents the orientation of an upper arm in relation to a lower arm of a subject (e.g., human subject 18 shown in FIGS. 1A and 1B). In this example, first angle 910 exceeding the first angle threshold may indicate that the lower arm is bent in relation to the adjacent upper arm. As a non-limiting example, the first threshold angle may be 20 degrees. Subsequently, an orthonormal coordinate system for left elbow virtual joint 318 may be ensured by calculating a left elbow orientation vector 908 as the normalized vector cross product of vector 902 and vector 906. The three left elbow virtual joint vectors 902, 906, and 908 together form an orthonormal coordinate system for left elbow virtual joint 318. Left elbow orientation vector 908, vector 902, and/or vector 906 may be associated with left elbow virtual joint 318 and made available via an API.

As shown in FIG. 9C, if, on the other hand, first angle 910 is equal to or falls below the first threshold angle (i.e., the upper and lower arms are nearly or substantially collinear), a second dot product of vector 902 and a vector 903 is calculated (shown in FIG. 9A), where vector 903 is equal to vector 504, described above. This dot product yields a second angle 911 between the shoulders and the upper arm. A second threshold angle may be 14 degrees, for example. If second angle 911 is greater than the second threshold angle (i.e., the elbow is not raised to near shoulder height), then left elbow orientation vector 908 is calculated as a cross product between vector 902 and vector 905 (shown in FIG. 9A). If the second angle is less than the second threshold angle but a third dot product between vector 902 and 905 is greater than zero (i.e., the upper arm and spine are not perpendicular), then left elbow orientation vector 908 is also calculated as the cross product between vector 902 and vector 905. A local orthonormal coordinate system may be ensured for left elbow virtual joint 318 by calculating a vector 912 as the normalized vector cross product of vector 902 and left elbow orientation vector 908. The three left elbow virtual joint orientation vectors 902, 908, and 912 together form an orthonormal coordinate system for left elbow virtual joint 318. Left elbow orientation vector 908, vector 902, and/or vector 912 may be associated with left elbow virtual joint 318 and made available via an API.

FIG. 9D shows a situation where second angle 911 falls below the second threshold angle, but the third dot product returns a result greater than zero (i.e., the upper arm and spine are not perpendicular). In such a case, the same vectors 902, 908, and 912 are associated with left elbow virtual joint 318, as described above.

However, as illustrated in FIG. 9E, if second angle 911 is less than the second threshold angle and the third dot product is not greater than zero, then left elbow orientation vector 908 is calculated as a cross product between vector 902 and vector 903 (shown in FIG. 9A). A local orthonormal coordinate system is ensured for left elbow virtual joint 318 by further defining a vector 916 as the normalized vector cross product of left elbow orientation vector 908 and vector 902. The three left elbow virtual joint orientation vectors 902, 908, and 916 together form an orthonormal coordinate system for left elbow virtual joint 318. Left elbow orientation vector 908, vector 902, and/or vector 916 may be associated with left elbow virtual joint 317 and made available by an API.

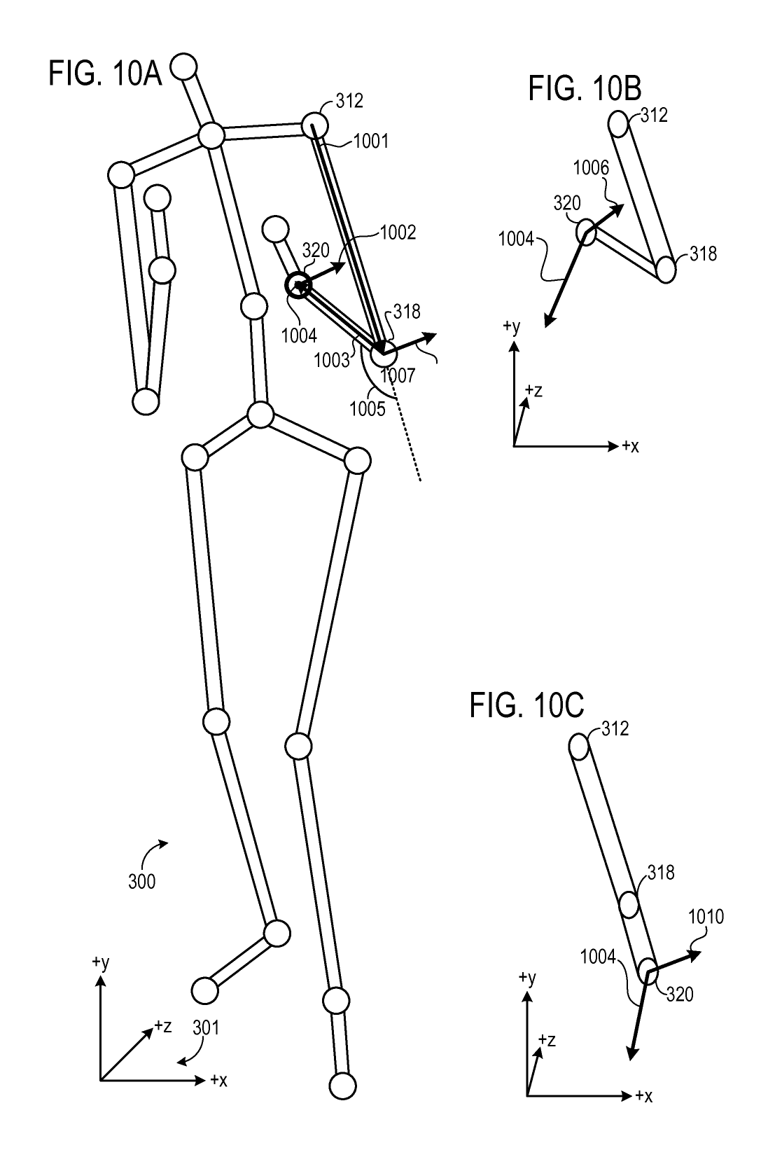

As seen in FIGS. 10A and 10B, a determination of an orientation of left wrist virtual point 320 begins with calculating a vector dot product of a vector 1001 and vector 1003, where vector 1001 is equal to vector 902, and vector 1003 is equal to vector 904, both described above and illustrated in FIG. 9A. If an angle 1005 determined by this dot product exceeds a threshold angle (i.e., the lower arm is bent in relation to the upper arm), an orientation of left wrist virtual joint 320 may be calculated by first finding a vector 1002 equal to the normalized vector cross product vector 1001 and vector 1003. As a non-limiting example, the threshold angle may be 20 degrees. Subsequently, an orientation of left wrist virtual joint 320 may be defined with a left wrist orientation vector 1004 equal to the normalized vector cross product of vector 1002 and vector 1003. An orthonormal coordinate system for left wrist virtual joint 320 may then be ensured by calculating a vector 1006 as the normalized vector cross product of vector 1003 and left wrist orientation vector 1004. The three left wrist virtual joint orientation vectors together form an orthonormal coordinate system for left wrist virtual joint 320. Left wrist orientation vector 1004 vector 1003, and/or vector 1006 may be associated with left wrist virtual joint 320 and made available via an API.

As shown in FIG. 10C, if, on the other hand, angle 1005 associated with the dot product falls below the threshold angle, left wrist, orientation vector 1004 may be calculated as the normalized vector cross product of a vector 1007 and vector 1003, where vector 1007 is equal to vector 916, described above. Subsequently, an orthonormal coordinate system may be ensured by calculating a vector 1010 equal to the normalized vector cross product of vector 1003 and left wrist orientation vector 1004. The three left wrist virtual joint orientation vectors 1003, 1004, and 1010 together form an orthonormal coordinate system for left wrist virtual joint 320. Left wrist orientation vector 1004, vector 1003, and/or vector 1010 may be associated with left wrist virtual joint 320 and made available via an API.

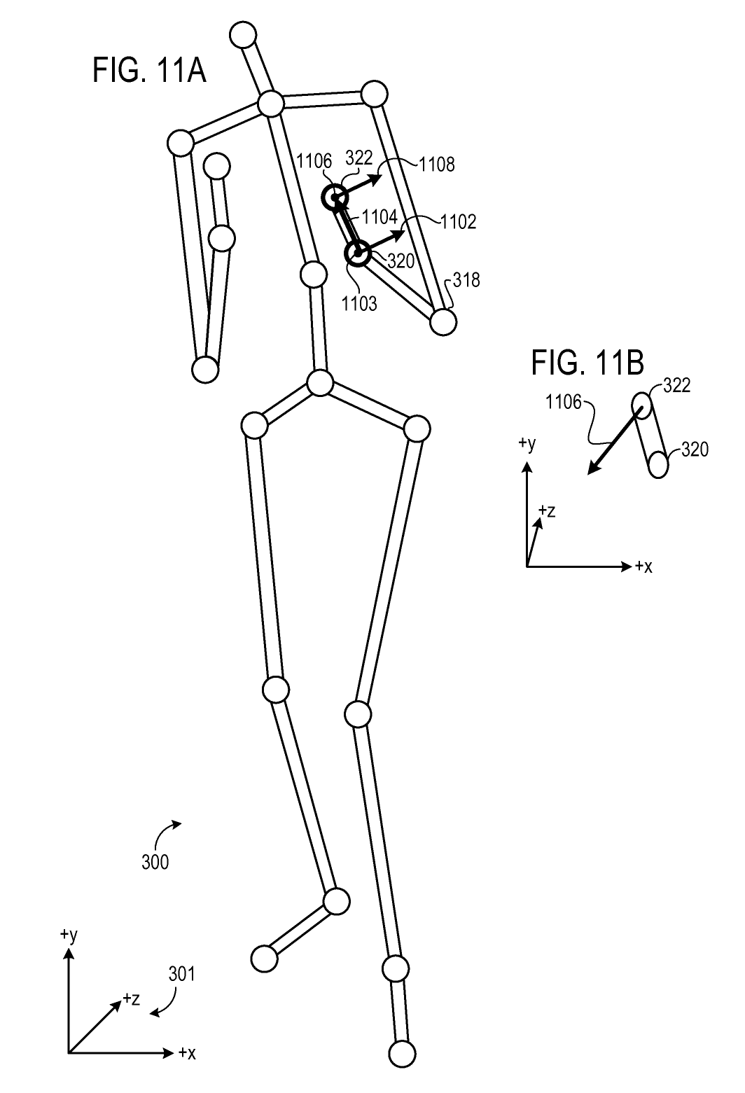

Turning now to FIGS. 11A and 11B, an orientation of left hand virtual joint 322 may be calculated by first finding a vector 1102 equal to the normalized vector cross product of a vector 1104 and a vector 1103, where vector 1104 extends between left wrist virtual joint 320 and left hand virtual joint 322, and vector 1103 is equal to vector 1004 described above. An orientation of left hand virtual joint 322 may then be defined with a left hand orientation vector 1106 equal to the normalized vector cross product of vector 1102 and vector 1104. An orthonormal coordinate system may be subsequently ensured for left hand virtual joint 322 by calculating a vector 1108 equal to the normalized vector cross product of vector 1104 and left hand orientation vector 1106. The three left hand virtual joint orientation vectors together form an orthonormal coordinate system for left hand virtual joint 322. Left hand orientation vector 1106, vector 1104, and/or vector 1108 may be associated with left hand virtual joint 322 and made available via an API.

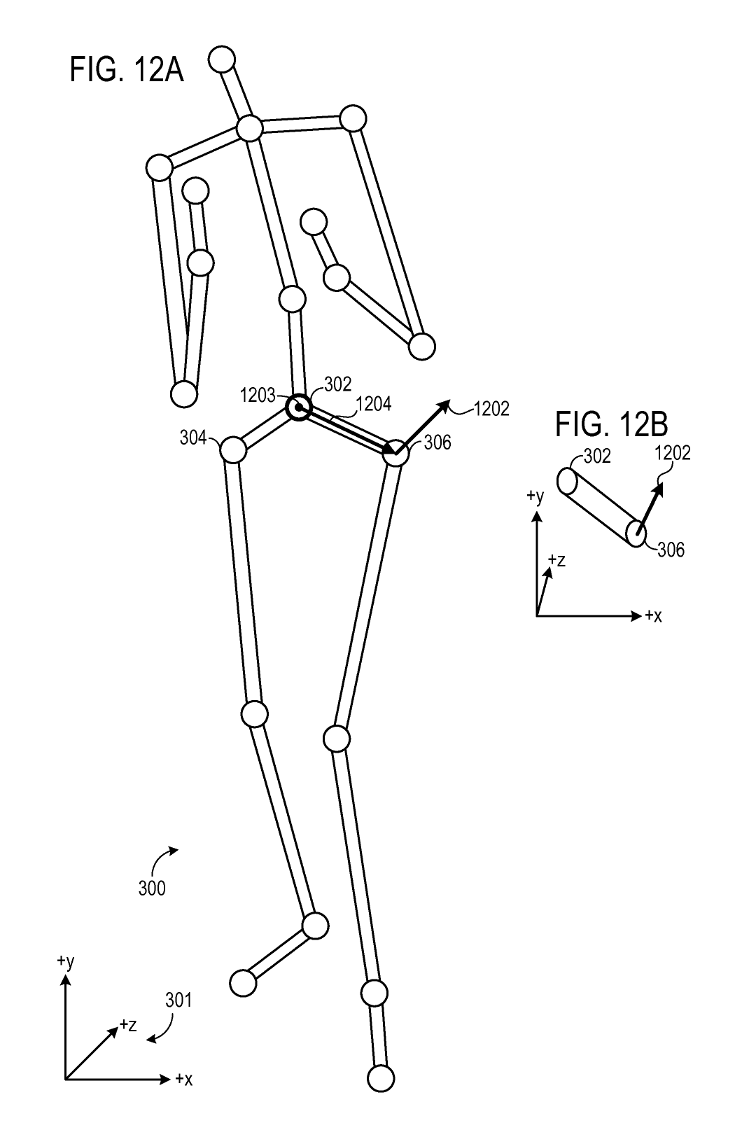

Moving to FIGS. 12A and 12B, an orientation of left hip virtual joint 306 may be defined with a left hip orientation vector 1202 equal to the normalized vector cross product, of a vector 1203 and a vector 1204, where vector 1203 is equal to vector 402, described above, and erector 1204 extends between hip center virtual joint 302 and left hip virtual joint 306. Left hip orientation vector 1202, vector 1203, and/or vector 1204 may be associated with left hip virtual joint 306 and made available via an API.

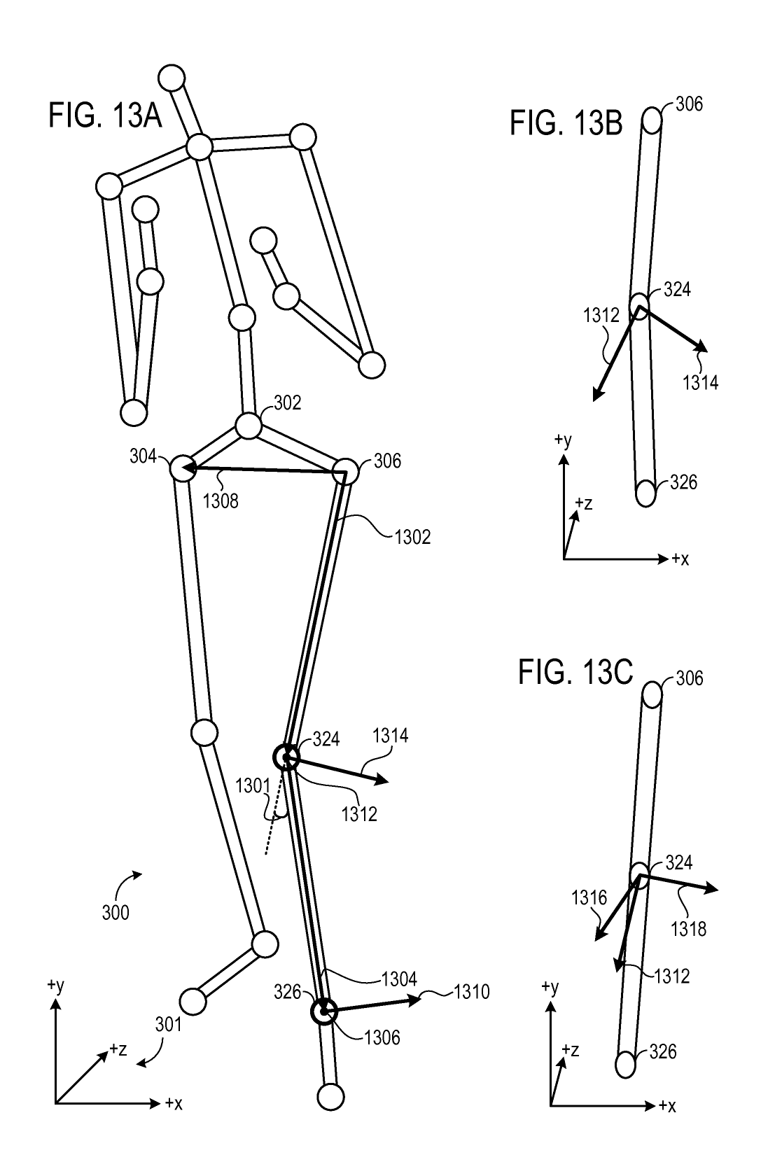

Turning now to FIGS. 13A and 13B, a calculation of an orientation of left knee virtual joint 324 begins with calculating a vector dot product of a vector 1302 and a vector 1304, where vector 1302 extends between left hip virtual joint 306 and left knee virtual joint 324, and vector 1304 extends between left knee virtual joint 324 and left ankle virtual joint 326. If an angle 1301 determined by this dot product exceeds a threshold angle (i.e., the lower leg is bent in relation to the upper leg), the lower leg is used to constrain the calculation. In this case, an orientation of left knee virtual joint 324 may be calculated by first finding a vector 1306 equal to the normalized vector cross product of a vector 1308 and vector 1304, where vector 1308 is opposite vector 404, described above. As a non-limiting example, the threshold angle may be 20 degrees. A vector 1310 is then calculated, equal to the normalized vector cross product of vector 1306 and vector 1304. Subsequently, an orientation of left knee virtual joint 324 may be defined with a left knee orientation vector 1312, equal to the normalized vector cross product of vector 1302 and vector 1310. An orthonormal coordinate system for left knee virtual joint 324 may then be ensured by calculating a vector 1314 as the normalized vector cross product of vector 1312 and vector 1302. The three left knee virtual joint orientation vectors together form an orthonormal coordinate system for left knee virtual joint 324. Left, knee orientation vector 1312, vector 1302, and/or vector 1314 may be associated with left knee virtual joint 324 and made available via an API.

As seen in FIG. 13C, if, on the other hand, angle 1301 associated with the dot product falls below the threshold angle, a vector 1316 is first calculated as the normalized vector cross product of vector 1308 and vector 1302. A vector 1318 is then calculated, equal to the normalized vector cross product of vector 1316 and vector 1302. Subsequently, an orientation of left knee virtual joint 324 may be defined with left knee orientation vector 1312, in this case equal to the normalized vector cross product of vector 1302 and vector 1318. The three left knee virtual joint, orientation vectors together form an orthonormal coordinate system for left knee virtual joint 324. Left knee orientation vector 1312, vector 1302, and/or vector 1318 may be associated with left knee virtual joint 324 and made available via an API.

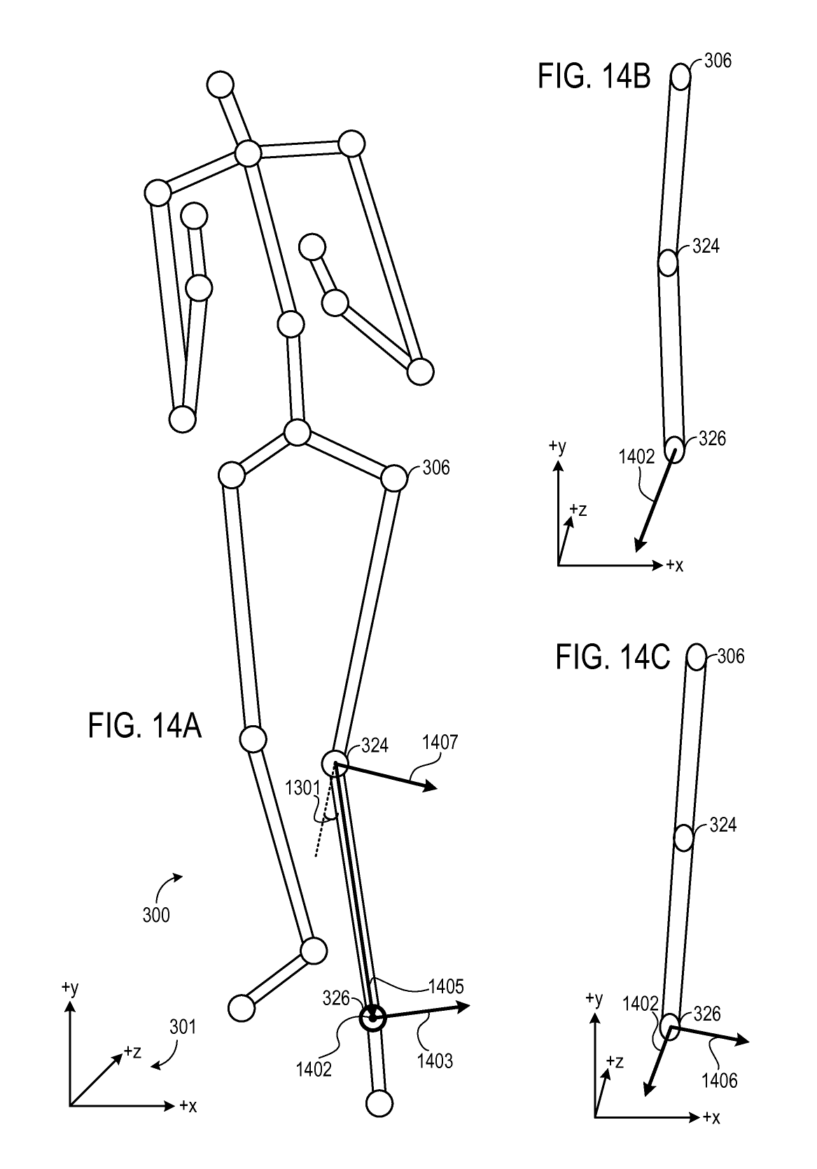

Turning now to FIGS. 14A and 14B a calculation of an orientation of left ankle virtual joint 326 begins with examining angle 1301 determined by the vector dot product calculated for left knee virtual joint 324. If the angle is greater than the threshold angle, the lower leg is used to constrain an orientation of left ankle virtual joint 326, which is defined with a left ankle orientation vector 1402, equal to the normalized vector cross product of a vector 1405 and a vector 1403, where vector 1405 is equal to vector 1304, and vector 1403 is equal to vector 1310, both described above. Left ankle orientation vector 1402, vector 1403, and/or vector 1405 may be associated with left ankle virtual joint 326 and made available via an API.

As seen in FIG. 14C, if, on the other hand, angle 1301 falls below the threshold angle, left ankle orientation vector 1402 may be calculated as the normalized vector cross product of vector 1405 and a vector 1407, where vector 1407 is equal to vector 1318, described above. An orthonormal coordinate system for left ankle virtual joint 326 may then be ensured by calculating a vector 1406 as the normalized vector cross product of vector 1402 and vector 1405. The three left ankle virtual joint orientation vectors 1402, 1405, and 1406 together form an orthonormal coordinate system for left ankle virtual joint 326. Left ankle orientation vector 1402, vector 1405, and/or vector 1406 may be associated with left ankle virtual joint 326 and made available via an API.

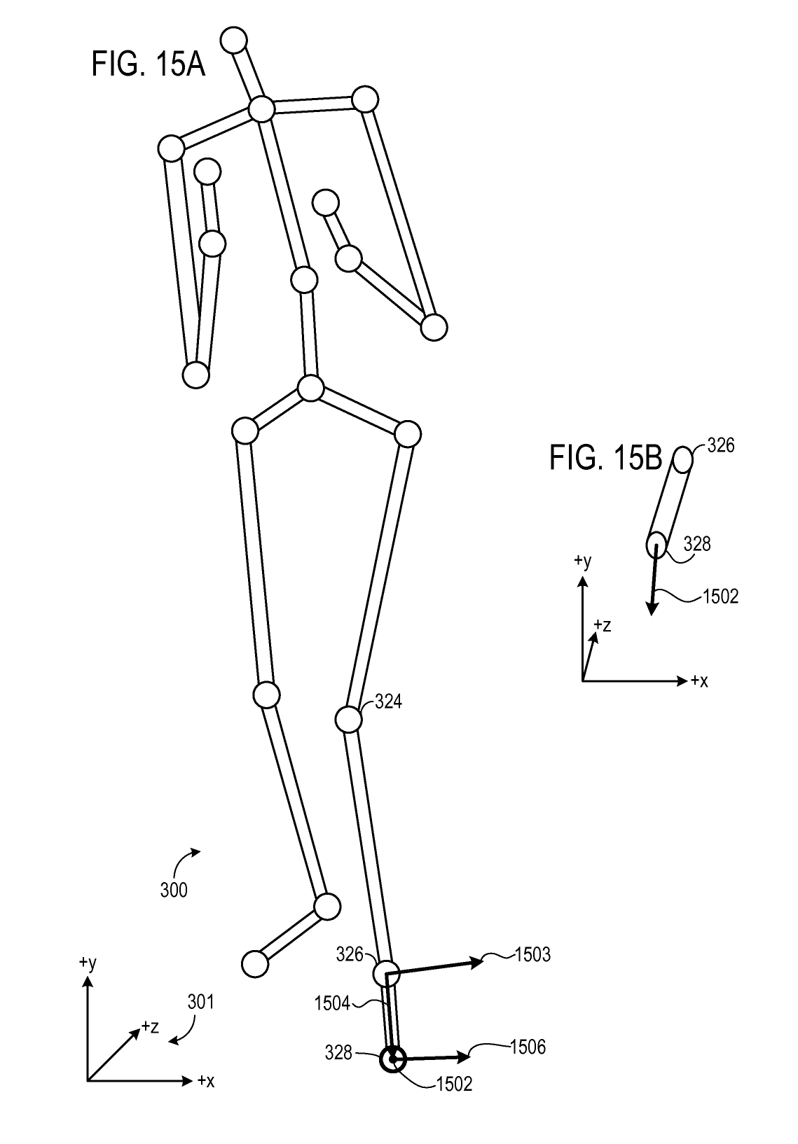

Moving to FIGS. 15A and 15B, an orientation of left foot virtual joint 328 may be defined with a left foot orientation vector 1502, equal to the normalized vector cross product of a vector 1504 and a vector 1503, where vector 1504 extends between left ankle virtual joint 326 and left foot virtual joint 328, and vector 1503 is equal to vector 1406 described above. An orthonormal coordinate system for left foot virtual joint 328 may then be ensured by calculating a vector 1506, equal to the normalized vector cross product of vector 1502 and vector 1504. The three left foot virtual joint orientation vectors 1502, 1504, and 1506 together form an orthonormal coordinate system for left foot virtual joint 328. Left foot orientation vector 1502, vector 1504, and/or vector 1506 may be associated with left foot virtual joint 328 and made available via an API.

If, for example, left foot virtual joint 328 is occluded (i.e., left foot virtual joint 328 is not visible from a tracking device's perspective), one coping mechanism includes assuming that the lower leg is straight and moving up the limb to find a next good orientation to use to proceed in the calculation. In this example, an orientation of left knee virtual joint 324 may be used in lieu of an orientation of left foot virtual joint 328. Such a coping mechanism may be applied to any occluded virtual joint in the virtual skeleton, though for some virtual joints the mechanism may not proceed up the virtual skeleton and may instead evaluate the closest neighboring joint for a good orientation and proceed outward until an acceptable orientation is found.

Orientations for the right side of virtual skeleton 300 may be calculated in the same manner as their respective counterparts on the left side of virtual skeleton 300.

it is to be understood that the above heuristics are not intended to be limiting. Joint orientations may be calculated with a variety of different heuristics without departing from the scope of this disclosure. In general, an orientation vector may be calculated via a normalized vector cross product of two vectors derived from positions of other virtual joints (e.g., a parent joint vector and a child joint vector). For example, the parent joint vector may point from an adjacent parent virtual joint to the virtual joint under consideration, while the child virtual joint vector may point from the particular virtual joint to an adjacent child virtual joint. In other examples, the two vectors may extend from and/or to centroids of the human subject's body parts, terminal ends of a human subject's extremities, midpoints between joints, and/or points without a direct anatomical link to the human subject.

Furthermore, in some embodiments, information other than virtual joint locations may be used to calculate joint orientations. As one nonlimiting example, raw information from a depth camera and/or visible light camera may be analyzed to assess joint orientations (e.g., relative eye, ear, and nose placements to estimate head orientation vector 702; thumb position relative to finger positions to estimate left hand orientation vector 1106, etc.).

In some embodiments, the methods and processes described above may be tied to a computing system including one or more computing devices. In particular, such methods and processes may be implemented as a computer-application program or service, an application-programming interface (API), a library, and/or other computer-program product.

FIG. 16 schematically shows a non-limiting embodiment of a computing system 1600 that can enact one or more of the methods and processes described above. As one nonlimiting example, computing system 1600 may execute the skeletal tracking pipeline described above with reference to FIG. 2. Computing system 10 of FIGS. 1A and 1B is a nonlimiting example implementation of computing system 1600. In FIG. 16, computing system 1600 is shown in simplified form. It will be understood that virtually any computer architecture may be used without departing from the scope of this disclosure. In different embodiments, computing system 1600 may take the form of a console gaming device, home-entertainment computer, desktop computer, laptop computer, tablet computer, network computing device, mobile computing device, mobile communication device (e.g., smart phone), augmented reality computing device, mainframe computer, server computer, etc.

Computing system 1600 includes a logic subsystem 1602, a storage subsystem 1604, an input subsystem 1606, a display subsystem 1608, a communication subsystem 1610, and/or other components not shown in FIG. 16.

Logic subsystem 1602 includes one or more physical devices configured to execute instructions. For example, the logic subsystem may be configured to execute instructions that are part of one or more applications, services, programs, routines, libraries, objects, components, data structures, or other logical constructs. Such instructions may be executed to enact the above described skeletal tracking pipeline, for example. In general, the instructions may be implemented to perform a task, implement a data type, transform the state of off one or more components, or otherwise arrive at a desired result.

The logic subsystem may include one or more processors configured to execute software instructions. Additionally or alternatively, the logic subsystem may include one or more hardware or firmware logic machines configured to execute hardware or firmware instructions. The processors of the logic subsystem may be single-core or multi-core, and the programs executed thereon may be configured for sequential, parallel or distributed processing. The logic subsystem may optionally include individual components that are distributed among two or more devices, which can be remotely located and/or configured for coordinated processing. For example, a console gam gaming device and a peripheral tracking device may both include aspects of the logic subsystem. Aspects of the logic subsystem may be virtualized and executed by remotely accessible, networked computing devices configured in a cloud-computing configuration.

Storage subsystem 1604 includes one or more physical, non-transitory, devices configured to hold data and/or instructions executable by the logic subsystem to implement the methods and processes described herein. When such methods and processes are implemented, the state of storage subsystem 1604 may be transformed—e.g., to hold different data and/or instructions.

Storage subsystem 1604 may include removable media and/or built-in devices. Storage subsystem 1604 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage subsystem 1604 may include volatile, nonvolatile, dynamic, static, read/write, read-only, random-access, sequential-access, location-addressable, file-addressable, and/or content-addressable devices.

it will be appreciated that storage subsystem 1604 includes one or more physical, non-transitory devices. However, in some embodiments, aspects of the instructions described herein may be propagated in a transitory fashion by a pure signal (e.g., an electromagnetic signal, an optical signal, etc.) that is not, held by a physical device for a finite duration. Furthermore, data and/or other forms of information pertaining to the present disclosure may be propagated by a pure signal.

In some embodiments, aspects of logic subsystem 1602 and of storage subsystem 1604 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

The terms “module,” “program,” “engine,” and “pipeline” may be used to describe an aspect of computing system 1600 implemented to perform a particular function. In some cases, a module, program, engine, or pipeline may be instantiated via logic subsystem 1602 executing instructions held by storage subsystem 1604. It will be understood that different modules, programs, engines, and/or pipelines may be instantiated from the same application, service, code block, object, library, routine, API, function, etc. Likewise, the same module, program, engine, and/or pipeline may be instantiated by different applications, services, code blocks, objects, routines, APIs, functions, etc. The terms“module,” “program,” “engine,” and “pipeline” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, input subsystem 1606 may comprise or interface with one or more user-input devices such as a tracking device (e.g., tracking device 20), keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, steroscopic, and/or depth camera for machine vision and/or gesture recognition; a head track eye tracker, accelerometer, and/or gyroscope for motion detection and/or intent recognition; as well as electric-field sensing componentry for assessing brain activity.

The input subsystem 1606 may include a depth camera or a depth-camera input configured to receive information from a peripheral depth camera. When included, the depth camera may be configured to acquire video of scene including one or more human subjects. The video may comprise a time-resolved sequence of images of spatial resolution and frame rate suitable for the purposes set forth herein. As described above with reference to FIG. 2, the depth camera and/or cooperating computing system may be configured to process the acquired video to identify one or more postures and/or gestures of the user, and to interpret such postures and/or gestures as input to an application and/or operating system running on computer system.

The nature and number of cameras may differ in various depth cameras consistent with the scope of this disclosure. In general, one or more cameras may be configured to provide video from which a time-resolved sequence of three-dimensional depth maps is obtained via downstream processing. As used herein, the term ‘depth map’ refers to an array of pixels registered to corresponding regions of an imaged scene, with a depth value of off each pixel indicating the depth of the corresponding region, ‘Depth’ is defined as a coordinate parallel to the optical axis of the depth camera, which increases with increasing distance from the depth camera.

In some embodiments, a depth camera may include right and left stereoscopic cameras. Time-resolved images from both cameras may be registered to each other and combined to yield depth-resolved video.

In some embodiments, a “structured light” depth camera may, be configured to project a structured infrared illumination comprising numerous, discrete features (e.g., lines or dots). A camera may be configured to ire age the structured illumination reflected from the scene. Based on the spacings between adjacent features in the various regions of the imaged scene, a depth map of the scene may be constructed.

In some embodiments, a “time-of-flight” depth camera may include a light source configured to project a pulsed infrared illumination onto a scene. Two cameras may be configured to detect the pulsed illumination reflected from the scene. The cameras may include an electronic shutter synchronized to the pulsed illumination, but the integration times for the cameras may differ, such that a pixel-resolved time-of-flight of the pulsed illumination, from the light source to the scene and then to the cameras, is discernible from the relative amounts of light received in corresponding pixels of the two cameras.

The input subsystem may include a visible light (e.g., color) or a visible-light-camera input configured to receive information from a peripheral visible-light camera. Time-resolved images from color and depth cameras may be registered to each other and combined to yield depth-resolved color video.

The input subsystem in may include one or more audio recording devices and/or audio inputs configured to receive audio information from peripheral recording devices. Ads a nonlimiting example, the audio recording device may include a microphone and an audio-to-digital converter. Audio recording devices may save digital audio data in compressed or uncompressed format without departing from the scope of this disclosure.

When included, display subsystem 1608 may be used to present a visual representation of data held by storage subsystem 1604. This visual representation may take the form of a graphical user interface (GUI). As the herein described methods and processes change the data held by the storage subsystem, and thus transform the state of the storage subsystem, the state of display subsystem 1608 may likewise be transformed to visually represent changes in the underlying data. Display subsystem 1608 may include one or more display devices utilizing virtually any type of technology. Such display devices may be combined with logic subsystem 1602 and/or storage subsystem 1604 in a shared enclosure, or such display devices may be peripheral display devices that communicate with computing system 1600 via a wired or wireless display output.

When included, communication subsystem 1610 may be configured to communicatively couple computing system 1600 with one or more other computing devices. Communication subsystem 1610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1600 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A skeletal tracking method, comprising:
receiving from a depth camera a depth map of a scene including a human subject;
modeling the human subject with a virtual skeleton including a plurality of virtual joints, each virtual joint defined with a three-dimensional position; and
further defining one or more of the plurality of virtual joints with three orthonormal vectors, the three orthonormal vectors for each virtual joint providing an orientation of that virtual joint at the three-dimensional position defined for that virtual joint.

2. A skeletal tracking method, comprising:
receiving from a depth camera a depth map of a scene including a human subject;
modeling the human subject with a virtual skeleton including a plurality of virtual joints, each virtual joint defined, with a three-dimensional position; and
further defining a particular one of the plurality of virtual joints with a three-dimensional orientation equal to a normalized vector cross product of two vectors derived from positions of other virtual joints.

3. The skeletal tracking method of claim 2, where the plurality of virtual joints include a hip center virtual joint, a left hip virtual joint, and a right hip virtual joint, and where the hip center virtual joint is defined with a hip center orientation vector equal to a normalized vector cross product of a first vector, between the right hip virtual joint and the left hip virtual joint, and a second vector, between the hip center virtual joint and an average center point of the left hip virtual joint and the right hip virtual joint.

4. The skeletal tracking method of claim 3, where the left hip virtual joint is defined with a left hip orientation vector equal to a normalized vector cross product of a third vector, between the hip center virtual joint and the left hip virtual joint, and the hip center orientation vector.

5. The skeletal tracking method of claim 2, where the plurality of virtual joints includes a left knee virtual joint, left hip virtual joint, left ankle virtual joint, and right hip virtual joint, and where, if an angle between a first vector extending between the left hip virtual joint acid the left knee virtual joint and a second vector extending between the left knee virtual joint and the left ankle virtual joint exceeds a first threshold angle, the left knee virtual joint is defined with a left knee orientation vector constrained by a lower leg of the virtual skeleton.

6. The skeletal tracking method of claim 5, where the left knee orientation vector is equal to a normalized vector cross product of the first vector and a third vector, where the third vector is equal to a normalized vector cross product of a fourth vector and the second vector, where the fourth vector is equal to a normalized vector cross product of a fifth vector and the second vector, where the fifth vector extends between the left hip virtual joint and the right hip virtual joint.

7. The skeletal tracking method of claim 5, where, if the angle does not exceed the first threshold angle, the left knee orientation vector is equal to a normalized vector cross product of the first vector and a sixth vector, where sixth vector is equal to a normalized vector cross product of seventh vector and the first vector, where seventh vector is equal to a normalized vector cross product of a fifth vector and the first vector, and where the fifth vector extends between the left hip virtual joint and the right hip virtual joint.

8. The skeletal tracking method of claim 5, where, if the angle exceeds a second threshold angle, the left ankle virtual joint is defined with a left ankle orientation vector constrained by the lower leg of the virtual skeleton.

9. The skeletal tracking method of claim 8, where the left ankle orientation vector is equal to a normalized vector cross product of the second vector and a third vector, where the third vector is equal to a normalized vector cross product of the second vector and a fourth vector, where the fourth vector is equal to a normalized vector cross product of a fifth vector and the second vector, and where the fifth vector extends between the left hip virtual joint and the right hip virtual joint.

10. The skeletal tracking method of claim 8, where, if the angle does not exceed the second threshold angle, the left ankle orientation vector is equal to a normalized vector cross product of a third vector and the second vector, where the third vector is equal to a normalized vector cross product of a fourth vector and the first vector, where the fourth vector is equal to a normalized vector cross product of a fifth vector and the first vector, and where the fifth vector extends between the left hip virtual joint and the right hip virtual joint.

11. The skeletal tracking method of claim 10, where the plurality of virtual joints includes a left foot virtual joint, and where the left foot virtual joint is defined with a left foot orientation vector equal to a normalized vector cross product of a sixth vector and a seventh vector extending between the left ankle virtual joint and the left foot virtual joint, and where the sixth vector is equal to a normalized vector cross product of the second vector and the left ankle orientation vector.

12. The skeletal tracking method of claim 2, where the plurality of virtual joints includes a hip center virtual joint, a spine virtual joint, a shoulder center virtual joint, a left shoulder virtual joint, and a right shoulder virtual joint, and where the spine virtual joint is defined with a spine orientation vector equal to a normalized vector cross product of a first vector, between the right shoulder virtual joint and the left shoulder virtual joint, and a second vector, between the hip center virtual joint and the spine virtual joint.

13. The skeletal tracking method of claim 12, where the plurality of virtual joints includes a head virtual joint, and where the head virtual joint is defined with a head orientation vector equal to a normalized vector cross product of the first vector and a third vector, between the shoulder center virtual joint and the head virtual joint.

14. The skeletal tracking method of claim 12, where the shoulder center virtual joint is defined with a shoulder center orientation vector equal to a normalized vector cross product of the first vector and a third vector, between the spine virtual joint and the shoulder center virtual joint.

15. The skeletal tracking method of claim 14, where the left shoulder virtual joint is defined with a left shoulder orientation vector equal to a normalized vector cross product of a fourth vector and a fifth vector extending between the shoulder center virtual joint and the left shoulder virtual joint, where the fourth vector is equal to a normalized vector cross product of the fifth vector and the shoulder center orientation vector.

16. The skeletal tracking method of claim where the plurality, of virtual joints includes a left shoulder virtual joint, a left elbow virtual joint, a left wrist virtual joint, a right shoulder virtual joint, a spine virtual joint, and a shoulder center virtual joint, and where, if a first angle between a first vector extending between the left shoulder virtual joint and the left elbow virtual joint and a second vector extending between the left elbow virtual joint and the left wrist virtual joint exceeds a first threshold angle, the left elbow virtual joint is defined with a left elbow orientation vector constrained by a lower arm of the virtual skeleton.

17. The skeletal tracking method of claim 16, where the left elbow orientation vector is equal to a normalized vector cross product of a third vector and the first vector, where the third vector is equal to a normalized vector cross product of the first vector and the second vector.

18. The skeletal tracking method of claim 16, where, if the first angle is equal to or falls below the first threshold angle, and if a second angle between the first vector and a third vector extending between the right shoulder virtual joint and the left shoulder virtual joint exceeds a second threshold angle, or if the second angle falls below the second threshold angle and a vector dot product between the first vector and a fourth vector extending between the spine virtual joint and the shoulder center virtual joint is greater than zero, the left elbow orientation vector is equal to a normalized vector cross product of the first vector and the fourth vector.

19. The skeletal tracking method of claim 18, where, if the second angle falls below the second threshold angle and the vector dot product is not greater than zero, the left elbow orientation vector is equal to a normalized vector cross product of the first vector and the third vector.

20. A skeletal tracking method, comprising:
receiving from a depth camera a depth map of a scene including a human subject;
modeling the human subject with a virtual skeleton including a plurality of virtual joints, each virtual joint defined with a three-dimensional position;
further defining one or more of the plurality of virtual joints with one or more orientation vectors; and
providing, via an Application Programming Interface, the three-dimensional position and the one or more orientation vectors for one or more of the plurality of virtual joints.
